(19) United States
(12) Patent Application Publication
(10) Pub. No.: US 2024/0145874 A1
(43) Pub. Date: May 2, 2024

(54) BATTERY MODULE AND BATTERY WITH SUCH BATTERY MODULES

(71) Applicant: HAWE Mattro GmbH, Schwaz (AT)

(72) Inventors: Patrick GUGLBERGER, Schwaz (AT); Jiri DOHNALEK, Schwaz (AT); Martin BERGER, Schwaz (AT); Philipp Lorenz BALLAUF, Schwaz (AT)

(21) Appl. No.: 18/495,999

(22) Filed: Oct. 27, 2023

(30) Foreign Application Priority Data
Oct. 28, 2022 (DE) 10 2022 211 494.9

(51) Int. Cl. H01M 50/507; H01M 10/643; H01M 10/6555; H01M 50/213; H01M 50/293; H01M 50/298; H01M 50/512; H01M 50/517; H01M 50/583

(52) U.S. Cl. CPC H01M 50/507; H01M 10/643; H01M 10/6555; H01M 50/213; H01M 50/293; H01M 50/298; H01M 50/512; H01M 50/517; H01M 50/583

(57) ABSTRACT

A battery module includes at least one first battery cell and at least one second battery cell, a support structure, a first bus bar and a second bus bar. The first battery cell and the second battery cell are received in the support structure in the same orientation. The first bus bar and the second bus bar are disposed on said support structure. The first battery cell and the second battery cell each have a first terminal and a second terminal. Furthermore, batteries that can be manufactured from one type of disclosed battery module are also disclosed. The batteries can be manufactured, for example, by serial interconnection using the coupling sections and parallel interconnection using the parallel circuit elements.

### CROSS REFERENCES TO RELATED APPLICATION

This application claims priority from German Patent Application No. 10 2022 211 494.9, filed on Oct. 28, 2022, the entire content of which is incorporated herein by reference in their entirety.

### FIELD OF THE INVENTION

The present invention relates to a battery module. Furthermore, the invention relates to a battery comprising such battery modules.

### BACKGROUND OF THE INVENTION

Such battery modules are known from the prior art. Such battery modules usually have a plurality of battery cells that can store and release electrical energy. A plurality of such battery modules, which are usually installed in a housing, form a battery that is used in particular in mobile applications, for example to supply mobile hydraulics with energy or to operate electrified vehicles.

Due to the ever-increasing requirements, it is necessary to provide battery modules of particularly simple design and modularity. It is therefore the object of the present invention to provide an improved battery module. It is further the object of the present invention to provide a battery having a plurality of battery modules according to the invention.

### SUMMARY OF THE INVENTION

The problem is solved with a battery module according to embodiments disclosed herein. Preferable embodiments are described in the dependent claims.

The battery module according to the invention comprises at least one first battery cell, at least one second battery cell, a support structure, a first bus bar and a second bus bar. The first battery cell and the second battery cell are received in the support structure in the same orientation. The first bus bar and the second bus bar are disposed on the support structure, and the first battery cell and the second battery cell each have at least a first terminal and a second terminal. Of course, the battery module according to the invention can also have more than two battery cells, although in the following, for the sake of simplicity, reference will be made to a battery module having two battery cells. For a battery module with three or more battery cells, the following explanations apply accordingly.

The first terminal can be the positive pole, for example, and the second terminal can be the negative pole, for example. In particular, the battery cells are cylindrical, with the second terminal being radially outside the first terminal. Preferably, exactly one support structure is provided so that the second terminal of the battery cells is freely available for thermal management.

Preferably, the first terminal of the first battery cell is connected to the first bus bar by a first wire and a second wire, wherein the first terminal of the second battery cell is connected to the first terminal of the first battery cell and the first bus bar via the first wire. Preferably, the second terminal of the first battery cell is connected to the second bus bar by a third wire. Preferably, the second terminal of the second battery cell is connected to the second bus bar via the third wire and preferably is connected to the second terminal of the first battery cell. Preferably, the second terminal of the second battery cell is connected to the second bus bar by a fourth wire. Thus, the respective terminals of the battery cells are bonded or connected to the corresponding bus bars via wires. This structure has the advantage that each battery cell is connected to the corresponding bus bar with the same ohmic resistance. Furthermore, this configuration has the advantage that each battery cell is individually fused and nevertheless contacts the bus bars with an optimally low ohmic resistance. Furthermore, this also results in a space- and cost-saving design, since the connection of several battery cells to the bus bars via one wire simplifies and reduces the size of the bus bars compared to the conventional design in which each individual wire always starts on one terminal of a single battery cell and ends on a bus bar.

According to the invention, the electrical connections between the battery cells and the bus bars are made via wires that are designed in terms of material and cross-section to function as an electrical fuse element and, in the event of overcurrent, to disconnect each battery cell individually from the module assembly. These wires can be connected to the battery cells, bus bars, sensors and the like, for example, by ultrasonic welding (also known as wirebonding), laser welding, resistance welding and similar common methods.

Preferably, the wires are made of a highly conductive material, preferably a highly conductive metallic material. Preferably, the wires are made of aluminum or an aluminum alloy. Of course, all wires or even individually selected wires can also be made of another material, for example copper.

Preferably, the first bus bar has a first coupling structure and the second bus bar has a second coupling structure, so that the first bus bar and the second bus bar can be connected to the bus bars of a further battery module.

Preferably, the support structure is made of a plastic. Preferably, the plastic comprises a polycarbonate or an acrylonitrile-butadiene-styrene or a mixture thereof. Preferably, the support structure is unreinforced and, in particular, free of glass fibers. This has the advantage that the so-called “swelling” (physical growth of the battery cells over the service life) can be better compensated with a more flexible, since unreinforced, support structure.

It may be preferable if the first bus bar is attached to the support structure via at least one self-tapping and non-conductive screw, for example a plastic screw, wherein the at least one self-tapping non-conductive screw has a head with an axial end, the axial end preferably being the axially outermost part of the battery module. By a plastic screw is meant in this context a screw made of a plastic or other insulating material. In this context, it is equally preferable if the second bus bar is attached to the support structure via at least one self-tapping non-conductive screw, the at least one self-tapping non-conductive screw having a head with an axial end, the axial end preferably being the axially outermost part of the battery module. Alternatively or additionally, it is conceivable that the bus bars are partially overmolded, preferably with a plastic.

Of course, a variety of non-conductive screws can be used to attach the first bus bar and/or the second bus bar to the support structure. The non-conductive screws thus serve to fasten the bus bars and also form insulating spacers to other parts, for example to a housing or other components surrounding the battery module.

Preferably, the non-conductive screws are glass-fiber filled or glass-fiber reinforced. Thus, the self-tapping non-conductive screws can be screwed directly into the support structure. Due to the glass fiber filling or reinforcement, damage to the non-conductive screw during screwing is largely excluded.

Preferably, the support structure has at least one first receptacle for the first battery cell and at least one second receptacle for the second battery cell, the first receptacle surrounding the first battery cell at least partially in the circumferential direction and the second receptacle surrounding the second battery cell at least partially in the circumferential direction. Thus, the battery cells are securely held in the support structure.

Preferably, the first receptacle has an axial extension which corresponds to at most 50% of the axial extension of the first battery cell. Correspondingly, it is preferable if the second receptacle has an axial extension which corresponds to at most 50% of the axial extension of the second battery cell. This ensures that the battery cells are held securely without the receptacles being too large.

Preferably, the first battery cell is disposed in a force-fit in the first receptacle and/or is bonded to the first receptacle. Preferably, the second battery cell is also disposed in a force-fit in the second receptacle and/or bonded to the second receptacle. It is also conceivable that the first battery cell and/or the second battery cell are additionally or alternatively held positively in the respective receptacle, for example by engaging the shape of the battery cells, e.g. the deformation which is usually introduced on the housing of the battery cell for the purpose of closing the cell. Frequently, this deformation is introduced in the negative pole of the cell in the vicinity of the positive pole.

Thus, it is not necessary for the battery module to have more than one support structure. Rather, it is sufficient if the battery module has only exactly one support structure. This has the advantage that free access to an axial end of each battery cell is possible. Furthermore, this also facilitates assembly, because the individual battery cells can be placed next to each other in a corresponding holding device for assembly of the battery module, and then the support structure and the bus bars can be mounted. The poles of the battery cells are then connected or bonded to the bus bars via the wires as described above.

Preferably, the first battery cell and the second battery cell are arranged parallel to each other.

According to the invention, the solution of the problem is achieved with a battery having at least one first battery module described above and at least one second battery module described above. The first battery module and the second battery module can thus be identical. According to the invention, the first battery cell of the first battery module and the first battery cell of the second battery module are aligned in the axial direction. According to the invention, the second battery cell of the first battery module and the second battery cell of the second battery module are aligned in the axial direction. Of course, a plurality of two battery modules (i.e., four, six, eight, etc.) can also be used, in which case the explanations apply accordingly.

Preferably, at least a first parallel circuit element connects the first bus bar of the first battery module to the first bus bar of the second battery module, wherein the first parallel circuit element preferably consists at least partially of aluminum or an aluminum alloy. In this context, it is preferable if a second parallel circuit element connects the second bus bar of the first battery module to the second bus bar of the second battery module, the second parallel circuit element preferably consisting at least partially of aluminum or an aluminum alloy.

Thus, by optionally arranging parallel circuit elements, the individual battery modules can be connected in parallel to achieve a design with increased capacity. Of course, it is conceivable that corresponding parallel circuit elements are disposed between all battery modules of the battery. It is also conceivable that no or only isolated parallel circuit elements are disposed between the battery modules. Thus, depending on the requirement, the battery can also be configured as a hybrid between parallel-connected and series-connected battery cells, with a series connection increasing the voltage of the battery.

This can be illustrated by an example. For example, a battery module can be constructed from one serial battery cell and 34 parallel battery cells. If, for example, 28 such battery modules are used for the entire battery, a battery with 28 serial battery cells and 34 parallel battery cells can be constructed from them, or a battery with 14 serial battery cells and 68 parallel battery cells, etc.

The parallel circuit elements can preferably be of tubular configuration in order to connect the bus bars. In particular, the parallel circuit elements have connecting elements at both axial ends that can be electrically contacted with the respective bus bars. One possible connecting element is a screw. It is also conceivable that the connecting elements can be pressed or crimped or are configured as springs for spring contacting.

Preferably, the first battery module is received in a first perforated plate by receiving the axial ends of the first battery cell and the second battery cell of the first battery module facing away from the support structure in corresponding holes of the first perforated plate. It is further preferable if the second battery module is received in a second perforated plate by receiving the axial ends of the first battery cell and the second battery cell of the second battery module facing away from the support structure in corresponding holes of the second perforated plate.

In particular, it is preferable if the first battery module is fixed to the second perforated plate, and in particular is screwed to the second perforated plate. Accordingly, it is preferable if the second battery module is fixed to the first perforated plate, and in particular is screwed to the second perforated plate. In this way, the necessary contact pressure is generated by simple means. Furthermore, this mutual connection allows the perforated plate to be configured as a simple 2D structure. This increases the number of available manufacturing methods for the perforated plate, which in turn has a favorable effect on the costs required to be able to produce a large number of different batteries from one type of battery module.

Preferably, a thermal plate is disposed between the first battery module and the second battery module. Heat can be dissipated quickly via the thermal plate. On the other hand, heat can also be supplied via the thermal plate, for example when used under arctic temperatures. The thermal plate is preferably formed from a highly thermally conductive material, for example aluminum or an aluminum alloy. Insofar as the thermal plate is only to be provided for heating, it can be constructed as a printed circuit board, for example as an FR-4 printed circuit board. This is a particularly cost-effective variant.

Preferably, a first thermally conductive layer is disposed between the thermal plate and the first battery module and/or if a second thermally conductive layer is disposed between the thermal plate and the second battery module. The thermally conductive layers may be thermally conductive films and in particular silicone films. The thermally conductive layers may also be gel or thermally conductive potting compound. Preferably, the thermally conductive layers are formed in such a way that there is no gap between the thermal plate and the respective battery cells. Such a gap could be due to tolerances, for example.

### BRIEF DESCRIPTION OF THE DRAWINGS

FIG. 1 is a side view of a battery according to the invention;

FIG. 2 is a section along line A-A shown in FIG. 1;

FIG. 3 is a top view of a battery with parallel circuit elements;

FIG. 4 is a section along line B-B shown in FIG. 3;

FIG. 5 is a top view of a battery without parallel circuit elements;

FIG. 6 is a section along line C-C shown in FIG. 5;

FIG. 7 is a top view of a single battery module; and FIG. 8 is an enlarged detail from FIG. 7.

### DETAILED DESCRIPTION OF THE INVENTION

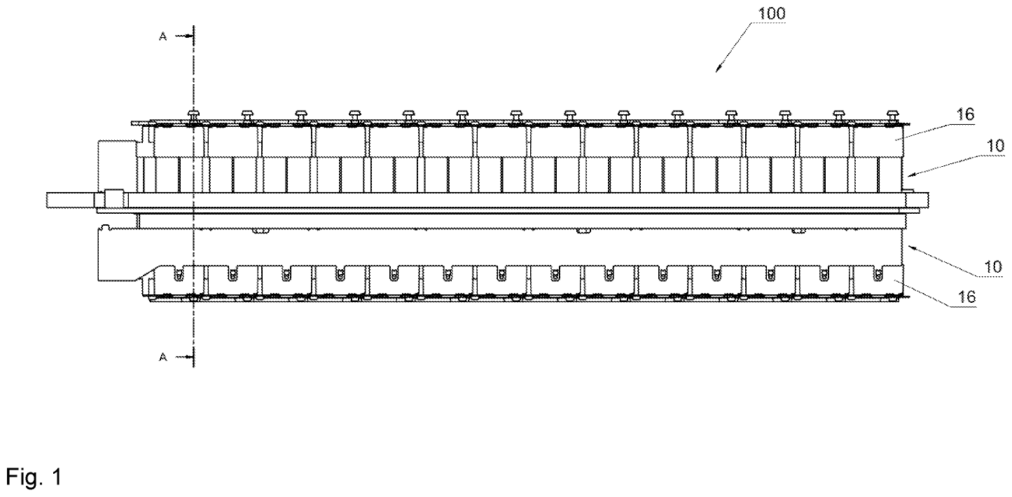

FIG. 1 shows a side view of a battery 100 according to the invention. The battery 100 has a plurality of battery modules 10. The battery modules 10 comprise a plurality of battery cells 12, 14, with only a first battery cell 12 and a second battery cell 14 being discussed below by way of example.

Each battery module 10 has exactly one support structure 16 as well as a first bus bar 18 and a second bus bar 20. The support structure 16 is made of a plastic, in particular a mixture of PC and ABS. The first bus bar 18 and the second bus bar 20 are attached to the support structure 16 via self-tapping, non-conductive screws 40, for example fiberglass-filled plastic screws. In other words, to secure the first bus bar 18 and the second bus bar 20, self-tapping plastic screws 40 are screwed into corresponding holes in the support structure 16. The bores are dimensioned in such a way that, due to the self-tapping effect of the plastic screws 40, a particularly good and secure connection is achieved. The plastic screws 40 each have a head whose axial end protrudes furthest from the support structure 16. In other words, in exemplary embodiment, in a side view, the axial end of the head of each plastic screw 40 is the outermost part of the respective battery module 10. This serves, on the one hand, for insulation and, on the other hand, also as a spacer, for example for a housing of the battery module 10.

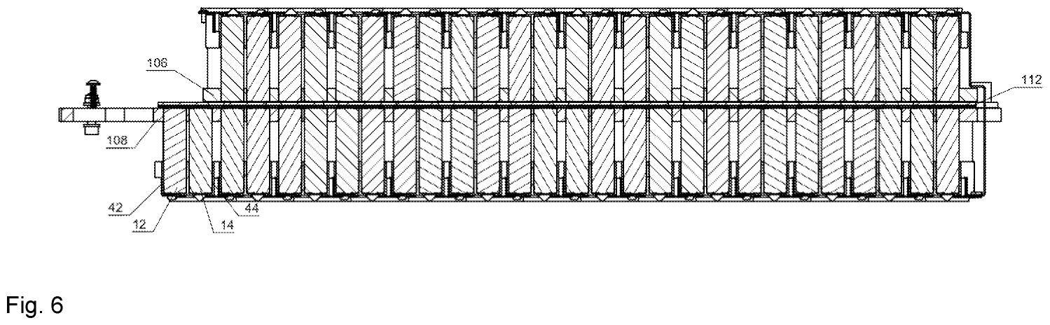

Further, the support structure 16 has a plurality of receptacles 42,44. Returning to the exemplary description of a first battery cell 12 and a second battery cell 14, it can be seen in particular in FIG. 6 that the first battery cell 12 is disposed in a first receptacle 42 and the second battery cell 14 is disposed in a second receptacle 44. The battery cells 12, 14 are received in the respective receptacle 42, 44 by a suitable connecting means. In this exemplary embodiment, the first battery cell 12 is bonded to the first receptacle 42 and the second battery cell 14 is bonded to the second receptacle 44. Additionally, the battery cells 12,14 may be positively or non-positively received in the respective receptacle 42,44.

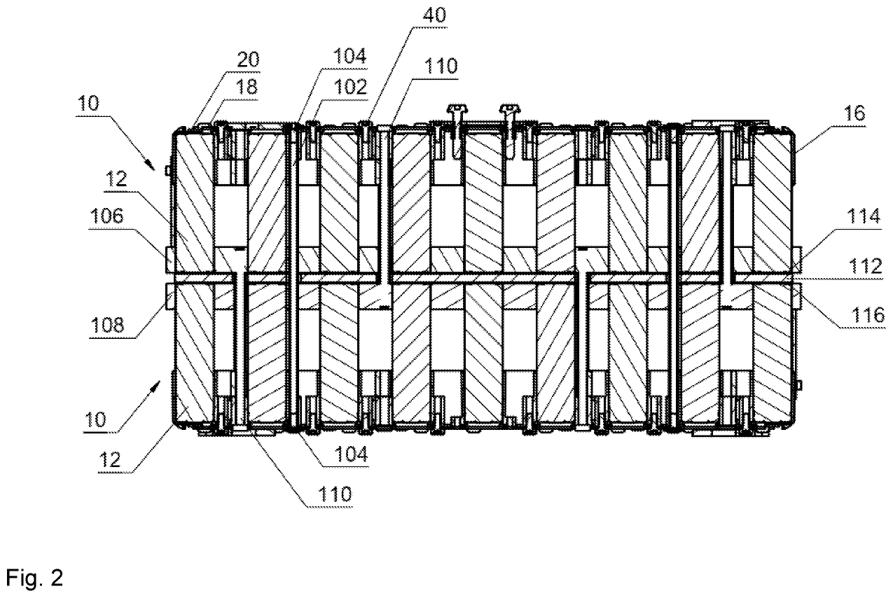

Furthermore, the battery 100 comprises a first perforated plate 106 and a second perforated plate 108, cf. e.g. FIG. 2. The axial ends of the battery cells 12,14 of a first battery module 10 are received in the respective holes of the first perforated plate 106. Accordingly, the axial ends of the battery cells 12,14 of a second battery module 10 are received in the respective holes of the second perforated plate 108. Of course, the axial ends of battery cells 12,14 of more than two battery modules 10 may be received in the respective perforated plates 106,108.

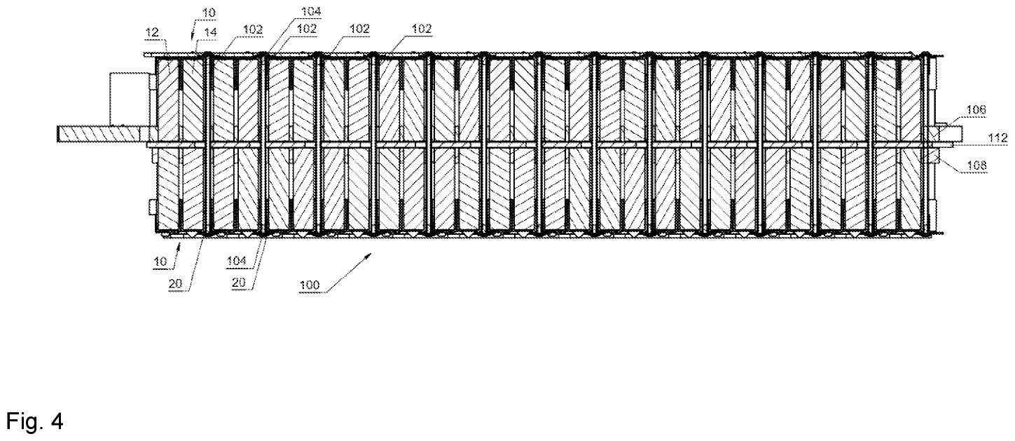

As can be seen in particular in FIGS. 2, 4 and 8, the battery cells 12, 14 are arranged, on the one hand, parallel to one another and, on the other hand, aligned in the axial direction. A thermal plate 112 may be disposed between the first perforated plate 106 and the second perforated plate 108. The thermal plate 112 may be coated on both sides with a foil 114,116. In particular, the foils 114,116 are a first thermally conductive layer 114 and a second thermally conductive layer 116. In particular, the foils 114,116 may be silicone foils.

The thermal plate 112 may be configured to either cool or heat the battery cells 12,14. Of course, different thermal plates 112 may be used as needed, for example, if only a cooling function is required.

In order to assemble the battery 100, the individual battery modules 10 are fixed to the perforated plates 106,108 by means of corresponding elongated screws 110. As can be seen in particular in FIG. 2, the first battery module 10 is screwed to the second perforated plate 108 via elongated screws 110. Correspondingly, the second battery module 10 is screwed to the second perforated plate 106 via elongated screws 110. This also generates the necessary contact pressure between the battery modules 10 and the thermal plate 112.

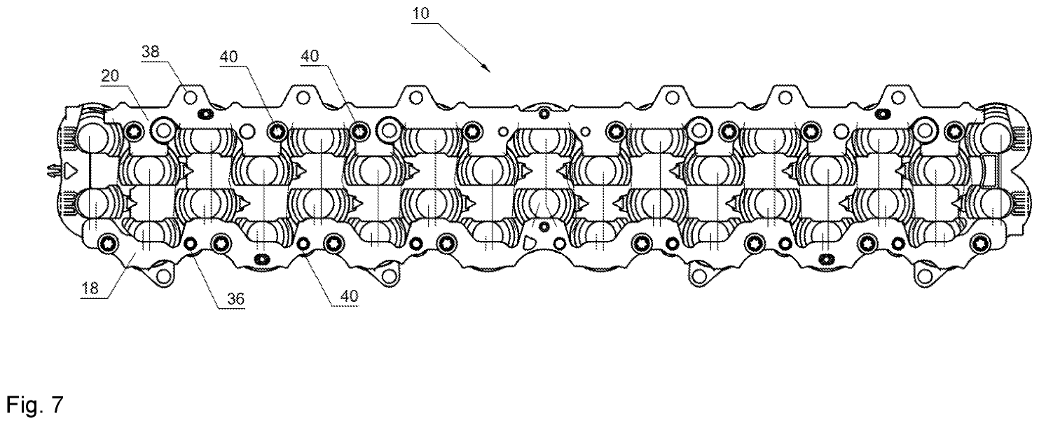

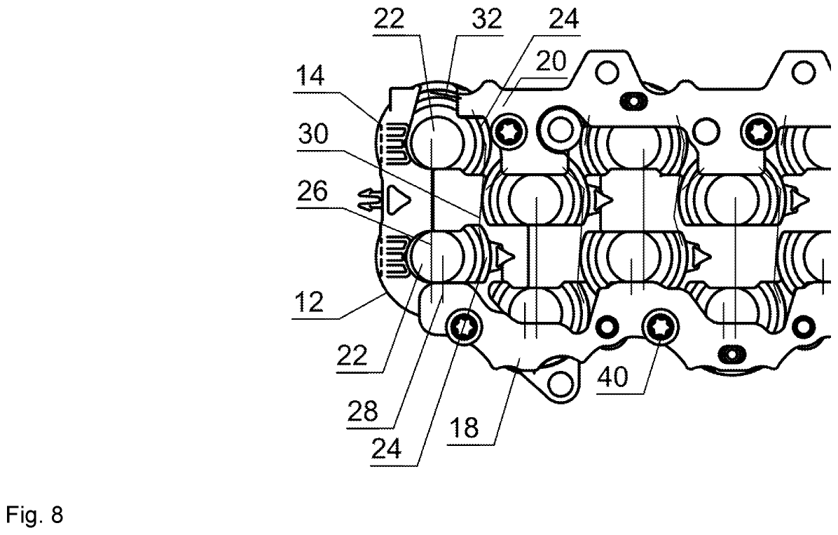

FIGS. 7 and 8 show a top view and a detail of a battery module 10, respectively. As shown, each battery cell 12,14 has a first terminal 22 and a second terminal 24. The first terminal 22 may be the positive pole, for example. The second pole 24 may be, for example, the negative pole. As shown, the second terminal 24 is disposed radially outward of the first terminal 22. Further, the terminals 22,24 of the battery cells 12,14 are connected to the bus bars 18,20 via a plurality of wires 26, 28, 30, 32.

As shown in particular in FIG. 8, the first terminal 22 of the first battery cell 12 is connected to the first bus bar 18 via a first wire 26. Further, the first terminal 22 of the first battery cell 12 is connected to the first bus bar 18 via a second wire 28. The first terminal 22 of the second battery cell 14 is also connected to the first bus bar 18 via the first wire 26. Consequently, the first terminal 22 of the second battery cell 14 is also connected to the first terminal 22 of the first battery cell 12 via the first wire 26. The second terminal 24 of the second battery cell 14 is connected to the second bus bar 20 via a third wire 30. In addition, the second terminal 24 of the second battery cell 14 is connected to the second bus bar 20 via a fourth wire 32. Furthermore, in this exemplary embodiment, the second terminal 24 of the first battery cell is also connected to the second bus bar 20, namely via the third wire 30.

Further, the wires 26, 28, 30, 32 are designed in terms of material and cross-section to function as an electrical fuse element and, in the event of overcurrent, to disconnect each battery cell 12, 14 individually from the module assembly 10. In this exemplary embodiment, the wires 26, 28, 30, 32 are connected to the battery cells 12, 14 by wirebonding.

The first bus bar 18 further comprises a first coupling section 36. The second bus bar 20 comprises a second coupling section 38. Individual bus bars 18, 20 of the plurality of battery modules 10 of a battery 100 can be connected via these coupling sections 36, 38.

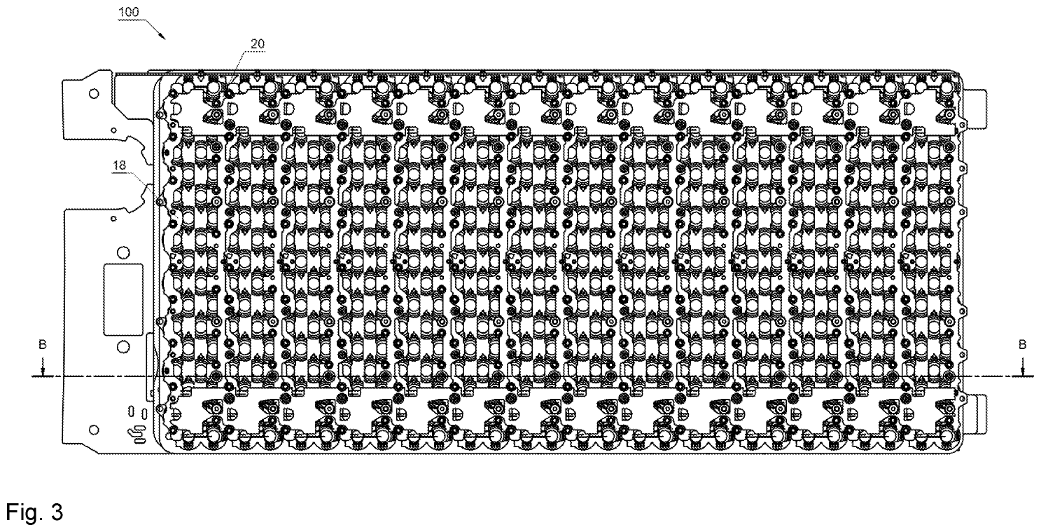

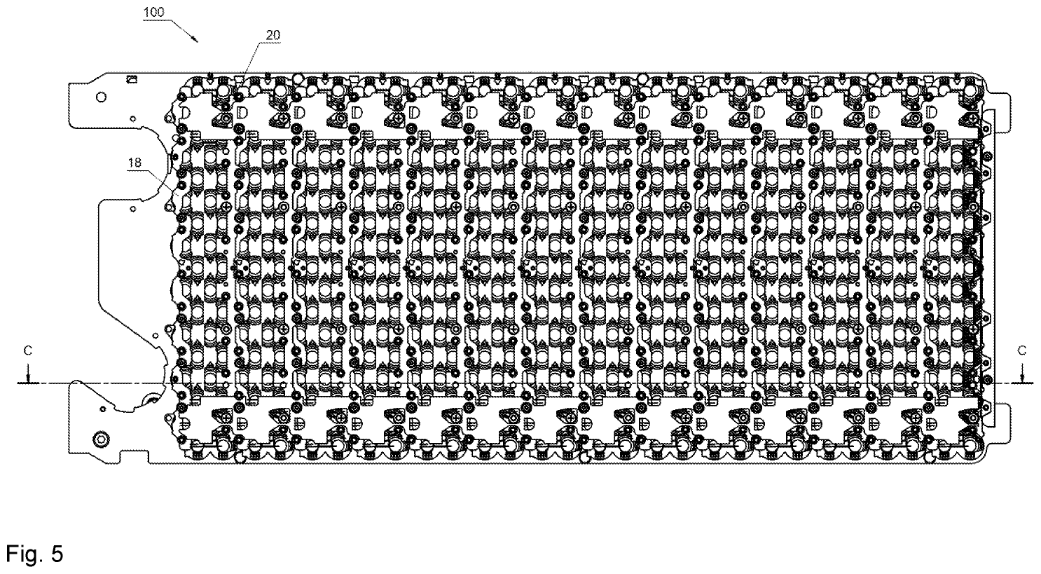

In addition, the battery 100 may optionally include electrical connection elements 102, for example in the form of parallel circuit elements 102. FIGS. 2, 3 and 4 show an embodiment of a battery 100 with parallel circuit elements 102. Correspondingly, FIGS. 5 and 6 show an embodiment of a battery 100 without parallel circuit elements 102.

In this embodiment, the parallel circuit elements 102 are formed as aluminum tubes that can extend through the first perforated plate 106, the second perforated plate 108 and, if present, the thermal plate 112 to connect the first bus bar 18 and the second bus bar 20, respectively, of two battery modules 10. For this purpose, the tubular parallel circuit elements 102 comprise connecting elements at both axial ends. In this embodiment, the connecting elements are formed as internal threads so that the parallel circuit elements 102 can be conductively fixed to the respective bus bar 18,20 via corresponding screws.

It should be noted that the numerical enumerations used herein, such as “first” or “second”, do not specify any particular or intended order of the elements, but are used solely for linguistic distinction. Thus, for the purposes of the invention, there may be, for example, a “second” element without a “first” element.

### List of Reference Signs

10 battery module

12 first battery cell

14 second battery cell

16 support structure

18 first bus bar

20 second bus bar

22 first terminal

24 second terminal

26 first wire

28 second wire

30 third wire

32 fourth wire

36 first coupling section

38 second coupling section

40 non-conductive screw

42 first receptable

44 second receptable

100 battery

102 parallel circuit element

104 screw

106 first perforated plate

108 second perforated plate

110 elongated screw

112 thermal plate

114 first layer

116 second layer

1. A battery module, comprising:
at least one first battery cell;
at least one second battery cell;
a support structure;
a first bus bar; and
a second bus bar,
wherein the first battery cell and the second battery cell are received in the support structure in the same orientation, said first bus bar and said second bus bar being disposed on said support structure, said first battery cell and said second battery cell each having a first terminal and a second terminal.

2. The battery module according to claim 1, wherein the first terminal of the first battery cell is connected to the first bus bar by a first wire and a second wire, wherein the first terminal of the second battery cell is connected to the first terminal of the first battery cell and the first bus bar via the first wire.

3. The battery module according to claim 2, wherein the second terminal of the first battery cell is connected to the second bus bar by a third wire.

4. The battery module according to claim 3, wherein the second terminal of the second battery cell is connected to the second bus bar via a third wire and is connected to the second terminal of the first battery cell.

5. The battery module according to claim 4, wherein the second terminal of the second battery cell is connected to the second bus bar by a fourth wire.

6. The battery module according to claim 5, wherein the first and second and third and fourth wires are formed as an electrical fuse element, so that in the event of an overcurrent the respective battery cell can be individually disconnected.

7. The battery module according to claim 5, wherein the first wire and/or the second wire and/or the third wire and/or the fourth wire are made of aluminum or an aluminum alloy.

8. The battery module according to claim 1, wherein the first bus bar comprises a first coupling structure, and wherein the second bus bar comprises a second coupling structure, such that the first bus bar and the second bus bar are connectable to bus bars of another battery module.

9. The battery module according to claim 1, wherein the support structure is made of a plastic, the plastic is unreinforced.

10. The battery module according to claim 1, wherein the first bus bar is secured to the support structure via at least one self-tapping non-conductive screw, the at least one self-tapping non-conductive screw having a head with an axial end, the axial end and/or wherein the second bus bar is secured to the support structure via at least one self-tapping non-conductive screw, the at least one self-tapping non-conductive screw having a head with an axial end.

11. The battery module according to claim 10, wherein the at least one self-tapping non-conductive screw is fiberglass filled.

12. The battery module according to claim 1, wherein the support structure comprises at least one first receptacle for the first battery cell and at least one second receptacle for the second battery cell, wherein the first receptacle at least partially circumferentially surrounds the first battery cell and wherein the second receptacle at least partially circumferentially surrounds the second battery cell.

13. The battery module according to claim 12, wherein the first battery cell is arranged in the first receptacle in a form-fitting or force-fitting manner and/or is bonded to the first receptacle and/or wherein the second battery cell is arranged in the second receptacle in a form-fitting or force-fitting manner and/or is bonded to the second receptacle.

14. The battery module according to claim 1, wherein the battery module comprises exactly one support structure.

15. The battery module according to claim 1, wherein the first battery cell and the second battery cell are arranged in parallel.

16. A battery comprising at least one first battery module and at least one second battery module according to claim 1, wherein the first battery cell of the first battery module and the first battery cell of the second battery module are aligned in the axial direction, and wherein the second battery cell of the first battery module and the second battery cell of the second battery module are aligned in the axial direction.

17. The battery according to claim 16, wherein at least a first parallel circuit element connects the first bus bar of the first battery module to the first bus bar of the second battery module and/or wherein a second parallel circuit element connects the second bus bar of the first battery module to the second bus bar of the second battery module.

18. The battery according to claim 16, wherein the first battery module is received in a first perforated plate by receiving the axial ends of the first battery cell and the second battery cell of the first battery module facing away from the support structure in corresponding holes of the first perforated plate, and wherein the second battery module is received in a second perforated plate by receiving the axial ends of the first battery cell and the second battery cell of the second battery module facing away from the support structure in corresponding holes of the second perforated plate.

19. The battery according to claim 18, wherein the first battery module is fixed to the second perforated plate, and in particular is screwed to the second perforated plate and/or wherein the second battery module is fixed to the first perforated plate, and in particular is screwed to the second perforated plate.

20. The battery according to claim 18, wherein a thermal plate is disposed between the first battery module and the second battery module.

21. The battery according to claim 20, wherein a first thermally conductive layer is disposed between the thermal plate and the first battery module and/or wherein a second thermally conductive layer is disposed between the thermal plate and the second battery module.

22. The battery according to claim 20, wherein the thermal plate is of a highly thermally conductive material.
